(19) United States
(12) Patent Application Publication
(10) Pub. No.: US 2005/0092737 A1
(43) Pub. Date: May 5, 2005

(54) Plug arrangement for a heating unit having PTC elements, in particular for a motor vehicle

(75) Inventors: Michel Brun, Rustenhart (FR); Christophe Schmittheisler, Epfig (FR); Pascal Miss, Selestat (FR); Maxime Mundel, Pfaffenheim (FR); Yannick Papi, Munchhouse (FR); Mathieu Mougey, Ensisheim (FR)

Correspondence Address: FOLEY AND LARDNER;SUITE 500, 3000 K STREET NW, WASHINGTON, DC, 20007, US

(73) Assignee: BEHR FRANCE S.A.R.L.

(21) Appl. No.: 10/956,350

(22) Filed: Oct. 4, 2004

(30) Foreign Application Priority Data
Oct. 2, 2003 (EP) 03 292 562.0

(51) Int. Cl. H05B 3/08

(52) U.S. Cl. 219/541; 219/507

(57) ABSTRACT

A plug arrangement (8) for a heating unit having at least one PTC element, in particular for a motor vehicle. The PTC element (2) is arranged between contact plates (3, 4) which serve for the electrical connection, and one contact plate (3) is designed at one of its ends as a plug (5) which has a hollow-cylindrical shape.

### CROSS-REFERENCE TO RELATED PATENT APPLICATIONS

The right of foreign priority under 35 U.S.C. § 119(a) is hereby claimed based on European Patent Application No. 03 292 562.0, filed Oct. 2, 2003, the entire disclosure of which is hereby incorporated by reference, including the specification, drawings, claims and abstract.

### BACKGROUND OF THE INVENTION

The invention relates to a plug arrangement for a heating unit having one or more PTC elements, in particular for a motor vehicle. In this type of arrangement, the PTC element is typically arranged between contact plates which serve for the electrical connection.

FIGS. 2 and 3 of DE 101 02 671 A1 disclose a flat plug arrangement via which voltage-conducting strip conductors of a circuit board are connected to a voltage-conducting supply line for PTC heating elements in the interior of the heating rods. The flat plug arrangement has bent tongues which bear resiliently against the supply line. A plug arrangement of this type still leaves room for improvement.

### SUMMARY OF THE INVENTION

It is therefore one object of the present invention to provide an improved plug arrangement.

It is a particular object to provide an improved plug arrangement for making electrical connection in a motor vehicle to a heating unit having at least one PTC heating element and to provide an improved motor vehicle embodying such an improved heating unit.

Another object of the invention is to provide an improved process for producing a plug arrangement, especially for electrically connecting a PTC element-containing heating unit in a motor vehicle.

In accomplishing the foregoing objects, there has been provided, in accordance with one aspect of the present invention, a plug arrangement for a heating unit suitable for use in a motor vehicle, the heating unit having at least one PTC element in contact with a conductive contact plate, the plug arrangement comprising: a female plug element having a hollow-cylindrical shape and being part of the contact plate and positioned at one of the ends of the contact plate.

In accordance with another aspect of the present invention, there has been provided a heating unit suitable for use in a motor vehicle, comprising at least one plug arrangement as defined above.

In accordance with another aspect of the present invention, there has been provided a motor vehicle, comprising a heating unit which includes at least one heating element, wherein the heating element comprises at least one PTC element in contact with at least a first conductive contact plate, and a plug arrangement for electrically connecting the PTC element to the vehicle, the plug arrangement comprising a female plug element having a hollow-cylindrical shape and being part of the first contact plate and positioned at one of the ends of the first contact plate.

In accordance with still another aspect of the present invention, there has been provided a method for manufacturing a plug arrangement for a heating unit suitable for use in a motor vehicle, the heating unit having at least one PTC element in contact with a conductive contact plate, the plug arrangement comprising a female plug element having a hollow-cylindrical shape and being part of the contact plate and positioned at one of the ends of the contact plate, the method comprising: providing respective incisions from opposite edges of the first contact plate, to form two opposing longitudinal edge regions at one end of the first contact plate, and then bending said opposing edge regions over to form a hollow cylinder.

Further objects, features and advantages of the present invention will become apparent from the detailed description of preferred embodiments that follows, when considered together with the accompanying figures of drawing.

### BRIEF DESCRIPTION OF THE DRAWINGS

The invention is explained in detail below using an exemplary embodiment and with reference to the drawings, in which:

FIG. 1 is a plan view of a heating unit according to the invention,

FIG. 2 is an enlarged cross-sectional view through a plug arrangement of the heating unit of FIG. 1,

FIG. 3 is a isolated perspective view showing a contact plate of the heating unit with part of the plug,

FIG. 4a is a perspective illustration showing the plug arrangement before it is plugged in, and

FIG. 4b is a perspective illustration showing the plug arrangement after it is plugged in.

### DETAILED DESCRIPTION OF THE PREFERRED EMBODIMENTS

The invention provides a plug arrangement for a heating unit, in particular for a motor vehicle, having at least one PTC element, wherein the PTC element is arranged between contact plates that serve for the electric connection. One contact plate is designed at one of its ends as a plug which has a hollow-cylindrical shape. This permits an electric and thermal connection with very good transmission of current and heat.

A pin onto which the plug is pushed is preferably provided as the mating element to the plug. This makes a particularly good connection possible.

The plug arrangement preferably has at least one heat dissipator for dissipating heat. The heat dissipator is preferably formed on the mating element to the plug. Integration of the heat dissipator in the plug arrangement enables the number of components to be reduced, and this, inter alia, reduces the production costs.

The hollow-cylindrical shape of the plug is preferably bent out of the contact plate by means of a forming process, i.e., the plug is formed integrally with the contact plate, as a result of which a separate contact connection is not required, and a secure electric connection between the contact plate and plug is ensured.

For this purpose, a respective incision is provided from opposite sides, preferably perpendicularly with respect to the longitudinal extent of the contact plate, and the two longitudinal edge regions of the contact plate are then bent over to form a hollow cylinder. This makes possible a very simple production of the plug.

In order to form an electrical connection, the plug can preferably be pushed onto a pin that is part of the mating element to the plug and that is fixed on a surface of a printed circuit board.

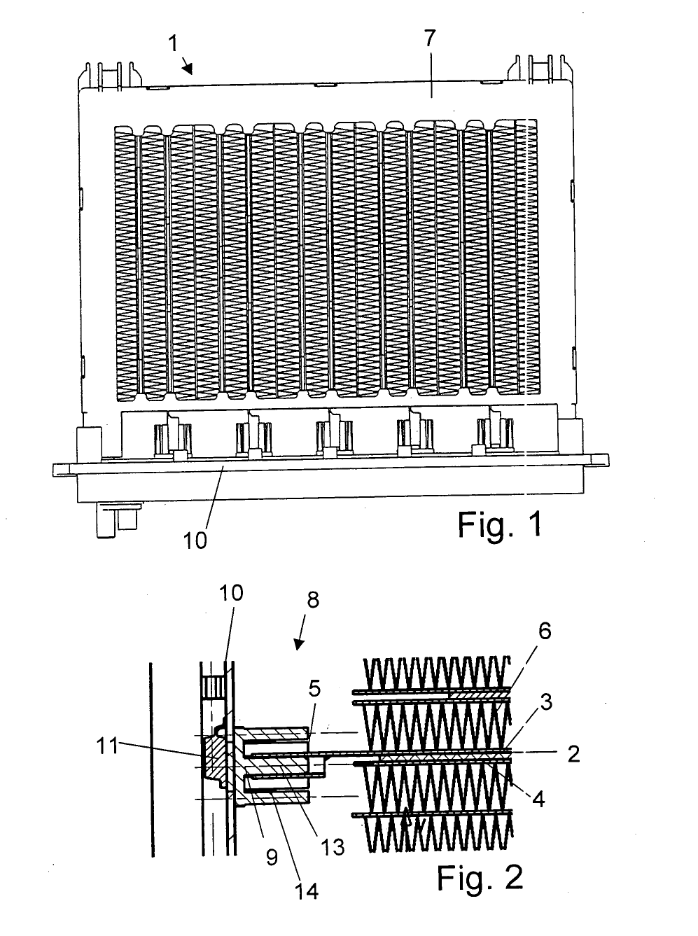

Turning now to the drawings, in particular FIGS. 1 and 2, in the PTC heating unit 1 having one or more PTC elements 2, a respective PTC element 2 is bonded in place, in the present case preferably by means of an adhesive, between two contact plates 3 (connected to ground) and 4 (connected to a grounding connection), which are arranged parallel to each other. For the electrical connection of the first contact plate 3, there is provided on one end of the contact plate a plug 5, which will be discussed in greater detail below.

Preferably, corrugated fins 6 are attached by means of a corresponding bonding arrangement, e.g., adhesive joint, on those sides of the contact plates 3 and 4 which in each case lie opposite the PTC element 2, and a respective further plate is attached to the opposite side of the corrugated fins, likewise again suitably with a corresponding adhesive joint. A frame 7, preferably made of plastic, is arranged around the previously described arrangement. The direction of flow of the air is in the viewing direction in FIG. 1.

The plug 5 is part of a plug arrangement 8 and interacts with a female mating element 9 which is preferably arranged on a printed circuit board 10, opposite a transistor 11. The plug 5 is preferably integrally formed with the contact plate 3, e.g., in the following preferred manner. A respective incision 12 (see FIG. 3) is provided from opposite sides, preferably perpendicularly, with respect to the longitudinal axis of the contact plate 3, and the two longitudinal edge regions of the contact plate 3 are then bent over at this end to form a hollow cylinder.

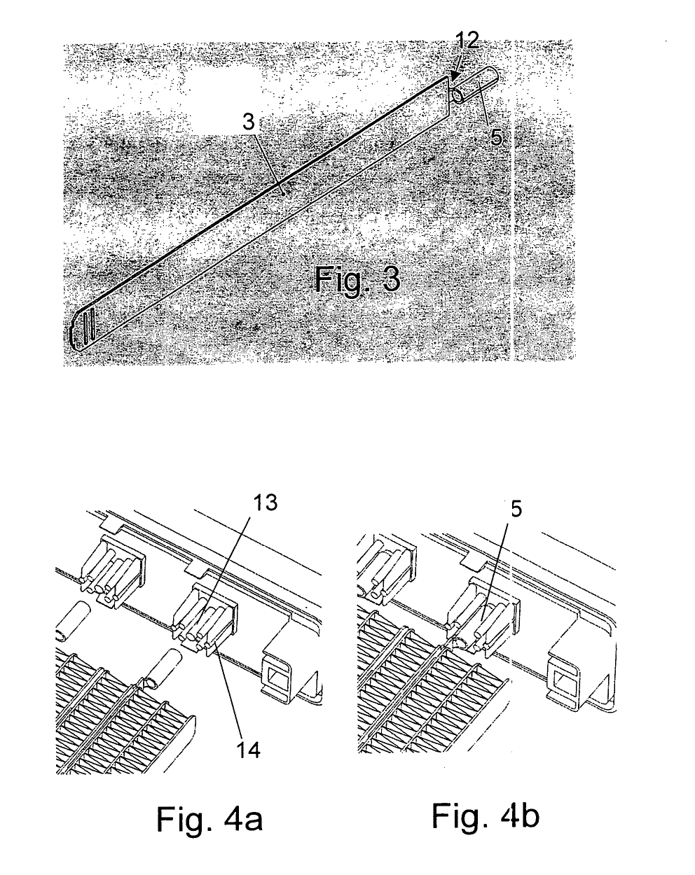

The mating element 9 has a pin 13, the diameter of which essentially corresponds to the inside diameter of the hollow cylinder of the plug, and the latter is pushed onto it during assembly. Furthermore, the mating element 9 preferably has a plurality of heat dissipators 14 that serve to dissipate heat and ensure that the electrical components, which are fixed in particular on the printed circuit board 10, are not overheated. Preferably, some of the heat dissipators 14 are designed as pins and some as pins provided with fins, as can be gathered in particular from FIG. 4a, which shows the components prior to plugging in of the PTC element(s). FIG. 4b shows the structure after the PTC elements are plugged in.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

1. A plug arrangement for a heating unit suitable for use in a motor vehicle, the heating unit having at least one PTC element in contact with a conductive contact plate, the plug arrangement comprising:
a female plug element having a hollow-cylindrical shape and being part of the contact plate and positioned at one of the ends of the contact plate.

2. A plug arrangement as claimed in claim 1, further comprising a mating male element to the plug comprising a pin onto which the plug can be pushed.

3. A plug arrangement as claimed in claim 2, wherein the plug arrangement further comprises at least one heat dissipator.

4. A plug arrangement as claimed in claim 3, wherein the at least one heat dissipator is connected to the mating male element.

5. A plug arrangement as claimed in claim 1, wherein the hollow-cylindrical shape of the female plug element is integrally formed from the contact plate.

6. A plug arrangement as claimed in claim 5, wherein the female plug element is formed by providing respective incisions from opposite edges of the contact plate, to form two opposing longitudinal edge regions at one end of the contact plate, and then bending said opposing edge regions over to form a hollow cylinder.

7. A plug arrangement as claimed in claim 6, wherein said incisions are made perpendicularly with respect to the longitudinal axis of the contact plate.

8. A plug arrangement as claimed in claim 2, wherein the pin is fixed on a surface of a printed circuit board.

9. A plug arrangement as claimed in claim 8, further comprising an electric component fixed on that side of the printed circuit board which lies opposite the plug arrangement.

10. A plug arrangement as claimed in claim 9, wherein the electrical component comprises a transistor.

11. A heating unit suitable for use in a motor vehicle, comprising at least one plug arrangement as claimed in claim 1.

12. A motor vehicle, comprising a heating unit which includes at least one heating element, wherein the heating element comprises at least one PTC element in contact with at least a first conductive contact plate, and a plug arrangement for electrically connecting the PTC element to the vehicle, the plug arrangement comprising a female plug element having a hollow-cylindrical shape and being part of the first contact plate and positioned at one of the ends of the first contact plate.

13. A motor vehicle as claimed in claim 12, further comprising a mating male element for the plug comprising a pin onto which the female plug element can, be pushed.

14. A motor vehicle as claimed in claim 13, wherein the plug arrangement further comprises at least one heat dissipator.

15. A motor vehicle as claimed in claim 14, wherein the at least one heat dissipator is connected to the mating male element.

16. A motor vehicle as claimed in claim 12, wherein the hollow-cylindrical shape of the female plug element is integrally formed from the first contact plate.

17. A motor vehicle as claimed in claim 16, wherein the female plug element is formed by providing respective incisions from opposite edges of the first contact plate, to form two opposing longitudinal edge regions at one end of the first contact plate, and then bending said opposing edge regions over to form a hollow cylinder.

18. A motor vehicle as claimed in claim 17, wherein said incisions are made perpendicularly with respect to the longitudinal axis of the first contact plate.

19. A motor vehicle as claimed in claim 13, wherein the pin is fixed on a surface of a printed circuit board.

20. A motor vehicle as claimed in claim 19, further comprising an electrical component fixed on that side of the printed circuit board which lies opposite the plug arrangement.

21. A motor vehicle as claimed in claim 20, wherein the electrical component comprises a transistor.

22. A method for manufacturing a plug arrangement for a heating unit suitable for use in a motor vehicle, the heating unit having at least one PTC element in contact with a conductive contact plate, the plug arrangement comprising a female plug element having a hollow-cylindrical shape and being part of the contact plate and positioned at one of the ends of the contact plate, the method comprising:
providing respective incisions from opposite edges of the first contact plate, to form two opposing longitudinal edge regions at one end of the first contact plate, and then bending said opposing edge regions over to form a hollow cylinder.

23. A method as claimed in claim 22, wherein said incisions are made perpendicularly with respect to the longitudinal axis of the contact plate.
